(19) United States
(12) Patent Application Publication
(10) Pub. No.: US 2007/0094668 A1
(43) Pub. Date: Apr. 26, 2007

(54) Method and apparatus for dynamically allocating resources used by software

(76) Inventors: Bryan J. Jacquot, Windsor, CO (US); Eric Hamilton, Mountain View, CA (US); Toshimitsu Kani, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/252,439

(22) Filed: Oct. 17, 2005

(51) Int. Cl. G06F 9/46

(52) U.S. Cl. 718/104

(57) ABSTRACT

Embodiments of the present invention pertain to methods and apparatuses are described for dynamically allocating resources used by software. In one embodiment, a script is received for a first piece of software. The script is associated with a system. The script enables the piece of software to respond to dynamic allocation of the resources. Further, another script is received for another piece of software. This script is also associated with the system and also enables the second piece of software to respond to dynamic allocation of the resources. By receiving the script, among other things, the system can be extended to provide dynamic allocation of the resources.

### TECHNICAL FIELD

Embodiments of the present invention relate to allocation of resources. More specifically, embodiments of the present invention relate to extending or contracting a system for dynamically allocating resources used by software.

### BACKGROUND ART

In today's computing world, the workload of a computing system may vary over time. For example, a single computer may execute several applications that require different amounts of resources, such as central processing units (CPUs), memory, and/or input output (I/O) devices, over time. As a result, dynamic resource allocation has been used to provide applications different amounts of resources depending on how many resources the application needs. For example, a computer system may have three CPUs and three memory devices that are shared between two applications (e.g., application A and application B) that execute on the computer system. In the morning, application A may require more resources while application B requires fewer resources. So the computer system's dynamic resource allocation program may allocate two of the CPUs and two of the memory devices to application A while allocating one CPU and one of the memory devices to application B in the morning. Later in the day, application B may require more resources while application A requires fewer resources, in which case, the dynamic resource allocation program may allocate two of the CPUs and two of the memory devices to application B. However, a problem may arise if the dynamic resource allocation program allocates resources to application B before application A is ready to give the resources up.

### DISCLOSURE OF THE INVENTION

Embodiments of the present invention pertain to methods and apparatuses are described for dynamically allocating resources used by software. In one embodiment, a script is received for a first piece of software. The script is associated with a system. The script enables the piece of software to respond to dynamic allocation of the resources. Further, another script is received for another piece of software. This script is also associated with the system and also enables the second piece of software to respond to dynamic allocation of the resources. By receiving the script, among other things, the system can be extended to provide dynamic allocation of the resources.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an apparatus for dynamically allocating resources used by software, according to embodiments of the present invention.

FIG. 2 is a block diagram of an exemplary system for dynamically allocating resources used by software, according to embodiments of the present invention.

FIG. 3 is a block diagram of an exemplary partitioned computer system for dynamically allocating resources used by software, according to another embodiment of the present invention.

FIG. 4 depicts a flowchart for dynamically allocating resources used by software, according to embodiments of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Software System and Functional Overviews

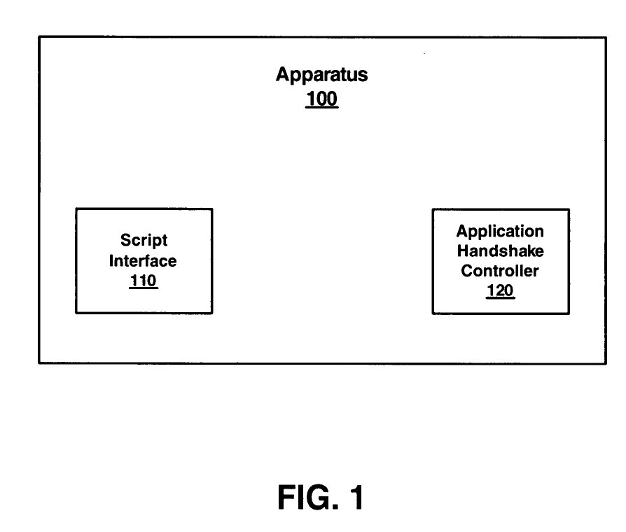

FIG. 1 depicts an apparatus for dynamically allocating resources used by software, according to embodiments of the present invention. The blocks in FIG. 1 can be arranged differently than as illustrated, and can implement additional or fewer features than what are described herein. Further, the features represented by the blocks in FIG. 1 can be combined in various ways. The apparatus 100 can be hardware, software, firmware, or a combination thereof. The apparatus 100 can be associated with a computer system. The apparatus 100 includes a script interface 110 and an application handshake controller 120. The script interface 110 can be used for adding scripts or removing scripts from a computer system that the apparatus 100 is associated with. The application handshake controller 120 can use the scripts as a part of dynamically allocating resources to software associated with the computer system. Further, the application handshake controller 120 can use the scripts to react to resources allocations to or de-allocations from the software application handshake controller. As will become more evident, the application handshake controller 120 can be associated with a platform manager or with an operating system, among other things.

As already stated, a problem may arise if the dynamic resource allocation program allocates resources to application B before application A is ready to give the resources up. Therefore, a need exists for a method and apparatus 100 for allocating resources in a manner that disrupts applications as little as possible and provides a notification to applications that system resources are being adjusted. The notification allows the application to take the necessary steps to properly react to the changes.

Further, conventional dynamic resource allocation programs do not provide an easy way of integrating applications with the apparatus 100 and application handshake controller 120. Therefore, a need exists for a method and an apparatus 100 for modifying (e.g., extend or reduce) a system's ability to dynamically allocate resources when an application is added or deleted from the system, among other things.

In another example, conventional dynamic resource allocation programs require a systems administrator to enter manual commands instructing the dynamic resource allocation program with regards to dynamically allocating resources. Therefore, a need exists for a method and an apparatus 100 that allocates resources without requiring manual commands.

According to embodiments of the present invention, an application handshake controller 120 uses scripts that are associated with software as a part of determining how to allocate resources with regards to the software. The software can be an application or an operating system, among other things. If software is added (for example by installing the software) to a computer system, one or more additional scripts can easily be associated with the computer system. The application handshake controller 120 can use the added scripts as part of informing applications that resources changes are being made. Similarly, if software is removed (for example by de-installing the software) from a computer system, the one or more scripts associated with that software can easily be removed from the computer system.

Therefore, an easy way of modifying a computer system's ability to dynamically allocate resources is provided, among other things, by adding and/or removing scripts to/from the system, as will become more evident. Further, as will become more evident, using scripts, among other things, allows the software to be involved in the determination of whether resources are allocated or de-allocated to/from the software. Thus, the disruption to software's performance is minimized and possibly even eliminated. Determining whether the allocation and/or de-allocation of resources will disrupt a piece of software is commonly referred to as “critical resource analysis.” Further, as will become more evident, by involving software in the allocation or de-allocation of resources can result in increased performance and a better customer experience.

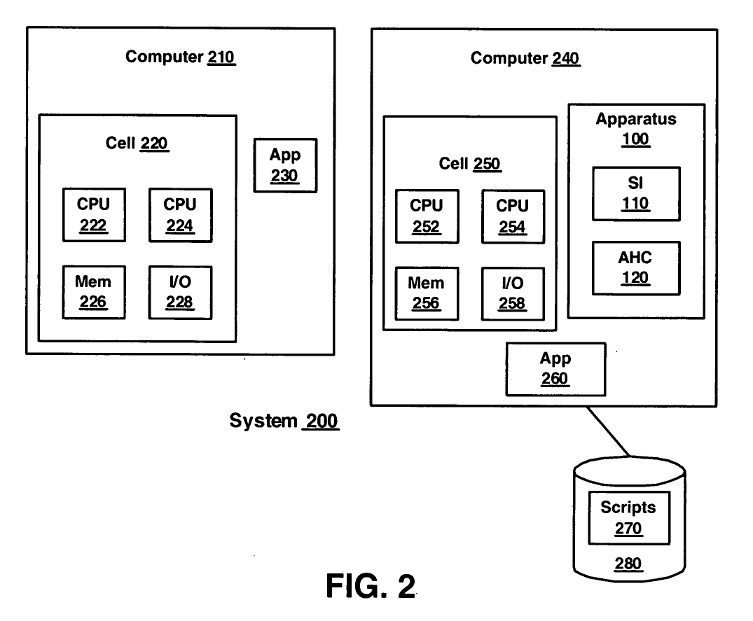

FIG. 2 is a block diagram of an exemplary system for dynamically allocating resources used by software, according to embodiments of the present invention. The blocks in FIG. 2 can be arranged differently than as illustrated, and can implement additional or fewer features than what are described herein. Further, the features represented by the blocks in FIG. 2 can be combined in various ways. The system, as depicted in FIG. 2, includes two computers 210, 240. Software, in the form of applications 230, 260 are associated with both computers 210, 240 as well as cells 220, 250 which include CPUs 222, 224, 252, 254, memory 226, 256, and I/O devices 228, 258. Cells 220, 250 can be used to associate various components with a computer. For example, a cell 220, 250 can be hot plugged into a computer 210, 240, thus associating various components on the cell 220, 250, such as CPUs 222, 224, 252, 254, memory 226, 256, and/or IO devices 228, 258, with the computer 210, 240. Computer 240 also includes an apparatus 100 with a script interface 110 and an application handshake controller 120.

In one example, an apparatus 100 as depicted in FIG. 2 could be used to give an application an opportunity to reconfigure their use of memory. For example, if an application, such as Oracle™, is given an opportunity to reconfigure their use of memory, CPUs and/or I/O devices, as a part of that process, the application could stop using the memory, CPUs and/or I/O devices that reside upon a cell that is to be removed. More specifically, the application could also adjust the number of threads in use based on the number of CPUs being allocated or de-allocated to that application. This is only one example of how embodiments of the present invention can be used.

In another example, an apparatus 100 as depicted in FIG. 2 can be used as a part of decommissioning a computer 210, which can involve migrating application 230 from computer 210 to computer 240. For example, application 230 can be removed from computer 230 and installed on computer 240. The script interface 110 can be used for adding one or more scripts, for example to scripts 270 stored on a device 280. The application handshake controller 120 can use the added scripts as a part of dynamically allocating and/or de-allocating resources 252, 254, 256, etc. to/from application 230 or 260. In so doing, computer 240's ability to provide dynamic allocation of resources can easily be extended.

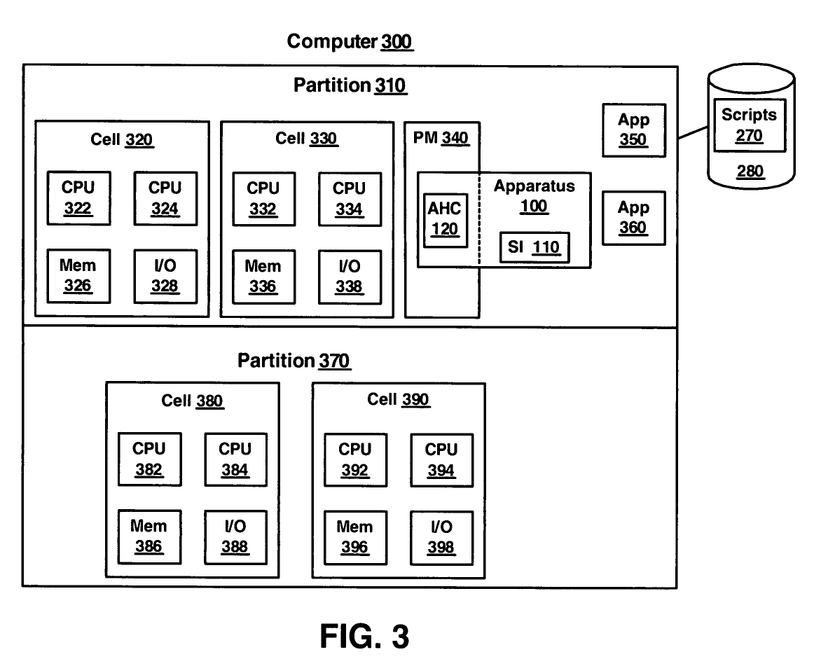

FIG. 3 is a block diagram of an exemplary partitioned computer system for dynamically allocating resources used by software, according to another embodiment of the present invention. The blocks in FIG. 3 can be arranged differently than as illustrated, and can implement additional or fewer features than what are described herein. Further, the features represented by the blocks in FIG. 3 can be combined in various ways. As depicted in FIG. 3, the computer 300 is partitioned into two partitions 310, 370. Different operating systems can reside on each of the partitions 310, 370. Partition 310 includes two cells 320, 330, a platform manager 340, an apparatus 100, two applications 350, 360, and scripts 270 that reside on device 280. The cells 320, 330, 380, 390 include resources, such as the respective CPUs 322, 324, 332, 334, 382, 384, 392, 394, memory 326, 336, 386, 396, and I/O devices 328, 338, 388, 398. The apparatus 100 includes an application handshake controller 120 and a script interface 110. The application handshake controller 120 of the apparatus 100 can also be a part of the platform manager 340. The scripts 270 can be stored on a storage device 280. As will discussed herein, the application handshake controller 120 can interact with the scripts 270 and the platform manager 340 to assist in migrating resources between the partitions 310, 370.

### Allocation of Resources

As already stated herein, examples of resources are CPUs, memory, and IO devices, among other things. These resources can be associated with a system. Examples of a system include the system 200 depicted in FIG. 2, or any computer 210, 240, 300 depicted in either FIG. 2 or FIG. 3. These resources can be associated with a system, for example, by being present when the system is booted or by hot plugging a cell into a system. According to embodiments of the present invention, software is involved in the determination of whether and/or how to allocate or de-allocate resources with respect to the software associated with a system. The term “allocate” can refer to allocating or de-allocating. This is frequently referred to as “allowing software to size itself” in the art.

Software is allowed to “size” itself before and/or after the resources with respect to a system are changed, for example, due to resources being allocated and/or de-allocated with respect to software. More specifically, resources can be allocated and/or de-allocated for example as the result of hot plugging a cell into a computer, migrating resources from one partition to another partition, determining that one piece of software, such as an application, no longer needs a resource and another piece of software, such as another application, could use that resource, among other things. Examples of types of operations that can be involved in the allocation or de-allocation include among other things, Cell OL* operations (OL stands for Online), Instant Capacitity, Virtual Partition migration of CPU resources, Virtual Machine resizing operations, Workload Management (WLM) resource partition resizing operations.

Examples of Cell OL* operations are Cell Online deletion and Cell Online Addition. With the Instant Capacity program, a server can be fully loaded with CPUs when deployed, yet a customer only pays for the CPUs that they plan to use with the exception of a normal up-front fee or “deposit.” When the customers needs change they can use instant capacity to instantly activate the needed CPUs with a simple UNIX(r) command. Further, CPUs can be automatically activated when a CPU failure is detected.

If an application, such as Oracle™, is given an opportunity to reconfigure their use of memory, CPUs and/or I/O devices, as a part of that process, the application could stop using the memory, CPUs and/or I/O devices that reside upon a cell that is to be removed. More specifically, the application could also adjust the number of threads in use based on the number of CPUs being allocated or de-allocated to that application. This is only one example of how embodiments of the present invention can be used.

### Software

According to embodiments of the present invention, a piece of software can be an application 230, 260, 350, 360 (FIGS. 2 and 3) or an operating system (such as the operating systems associated with computers 210, 240 depicted in FIG. 2 or the operating systems associated with partitions 310, 370 depicted in FIG. 3), among other things. The applications can be applications that are typically involved in resource allocation issues, such as Oracle™ or BEA. Further, the software may be a workload application, such as HP™'s WORKLOAD MANAGER (WLM), or a web server.

The software may be aware of the hardware topology and optimize for performance or for correctness of the hardware topology. Oracle™ databases are an example of software that is aware of hardware topologies.

### Application Handshake Controller

An application handshake controller 120 can involve a piece of software in determining how resources are to be allocated. For example, before a resource is allocated to or de-allocated from a piece of software, a application handshake controller 120 can execute one or more scripts 270 associated with that piece of software to determine how the allocation and /or de-allocation might affect the piece of software. The application handshake controller 120 can use the information provided by the scripts in determining whether to proceed with the allocation and/or de-allocation. An allocation can be due to a resource being added to a system for example due to plugging a cell into the system or to re-allocating a resource from one piece of software to another, among other things for example as described herein. A de-allocation can be due to a resource being removed from a system, for example due to a cell being removed from a system or to a resource being re-allocated from one piece of software to another, among other things for example.

An application handshake controller 120 can be associated with an operating system or with a platform manager 340. In the case of the application handshake controller 120 depicted in FIG. 2, the application handshake controller 120 can be involved in critical resource analysis (CRA) performed by the apparatus 100 to allow applications to prepare for the upcoming resource changes, according to one embodiment. In the case of the application handshake controller 120 depicted in FIG. 3, the platform manager 340 can communicate with application handshake controller 120 in determining how and/or when it is acceptable to move resource from one partition 210, 370 to another 310, 370, among other things. Further, the application handshake controller 120 (FIG. 3) can also be involved in critical resource analysis (CRA).

By using scripts 270 and/or an application handshake controller 120, resource allocation can be performed automatically without requiring a systems administrator to enter manual commands. For example, as systems become more and more dynamic, resources may be moved to one partition during one part of the day and moved to another partition during another part of the day. This can be done automatically without the use of manual commands, according to embodiments of the present invention. In addition, the operations can be more reliable because applications can be notified of changes in resources before the changes occur, according to one embodiment.

### Scripts

Scripts 270 can provide an easy way of modifying a computer system's ability to dynamically allocate resources. Further, scripts can allow software to be involved in the determination of whether resources are allocated or de-allocated for use by the software. Thus, the disruption to software's performance is minimized if not eliminated.

Allocating a resource to a piece of software or de-allocating a resource from a piece of software can affect the piece of software's performance. Similarly, adding, removing, and/or migrating software to/from a system, such as the system 200 depicted in FIG. 2 or the computer 210, 240, 300 depicted in FIG. 2 or FIG. 3, among other things, can impact how resources are allocated to various pieces of software associated with the system.

According to another embodiment, the software can be involved in determining how resources are dynamically allocated. For example, as discussed herein, scripts can be used for allowing software to be involved in how resources are dynamically allocated. More specifically, when a resource is about to be removed from use for an application, a script associated with that application can be executed to determine the impact that removing the resource will have on the application, as discussed herein. The script, for example, can indicate that the removal of a resource would severely impact the performance of an application or possibly even make it impossible for an application to perform, among other things.

Further, scripts can be used for determining whether the allocation or de-allocation of a resource would result in a violation of a service agreement, for example, between a company that owns a piece of software, such as an application, and another company that runs the system that the software resides on. For example, the two companies may enter into a service agreement that the application will be provided enough resources to execute within a certain range of speed. De-allocating a resource could lower the speed at which the application can execute so that the service agreement is violated. Similarly, allocating a resource could increase the speed so that the application is being provided more resources than it is entitled to based on the service agreement. A script associated with the application could be used for determining whether the service agreement would be violated prior to actually allocating or de-allocating a resource.

The scripts can be stored in a script structure such as a file system or a directory, which according to one embodiment, provides a way of adding/removing scripts from a system. For example, the scripts can be stored in storage device at a directory that has a similar structure to the “rc” directory such as “/usr/sbin/ah.d/.” Since system's administrators are familiar with “rc scripts”, this makes it easy for system's administrators and application developers to adopt. According to one embodiment, one or more scripts can be associated with each application. TABLE 1 below, depicts three alternative script structures (e.g., directory 1, 2, 3) for storing one or more scripts with each application associated with a system, according to embodiments of the present invention.

TABLE 1
script structures

| Line No. | Script structure2 |
|---|---|
| 1 | /directory 1 |

| | |
|---|---|
| 2 | script A |
| 3 | script B |

| | |
|---|---|
| 4 | /directory 2 |

| | |
|---|---|
| 5 | script A1 |
| 6 | script A2 |
| 7 | script B1 |
| 8 | script B2 |

| | |
|---|---|
| 9 | /directory 3 |

| | |
|---|---|
| 10 | /subdirectory A |

| | |
|---|---|
| 11 | script A1 |
| 12 | script A2 |

| | |
|---|---|
| 13 | /subdirectory B |

| | |
|---|---|
| 14 | script B1 |
| 15 | script B2 |

Assume for the sake of illustration that two applications are associated with a system. According to one embodiment, one script is associated with each piece of software. For example, a script A (line 2) can be associated with an application A and the script B (line 3) can be associated with an application B. According to another embodiment, more than one script can be associated with each piece of software. For example, scripts Al, A2 (lines 5, 6) can be associated with application A and scripts B1, B2 (lines 7, 8) can be associated with application B.

In yet another embodiment, scripts can be organized using subdirectories, such as subdirectory A (line 10) and subdirectory B (line 13). For example the scripts A1, A2 (lines 11, 12) associated with an application A can be organized under one subdirectory A (line 10) and scripts B1, B2 (lines 14, 15) associated with an application B can be organized under another and directory B (line 13). More complex script structures, such as directory 2 and directory 3, can be used for example for complex applications. For example, one script associated with the application can be executed to deal with the allocation and/or de-allocation of resources. A second script associated with the application can be executed to adjust the number of threads that the application will use, for example.

According to embodiments of the present invention, each script performs various actions depending on what arguments are passed into the scripts. The following depicts a TABLE 2 that shows a synopsis of a script as well as the actions the script can perform, according to embodiments of the present invention, followed by a description of TABLE 2.

TABLE 2
synopsis of a script according to embodiments
of the present invention.

| | |
|---|---|
| Line No. | Lines of synopsis |

| | |
|---|---|
| 1 | /usr/sbin/ah.d/<NNN><application> action |

| | | |
|---|---|---|
| 2 | [−c cell id | [−c ...]] |
| 3 | [−C cpu id | [−C ...]] |
| 4 | [−m memory id | [−m ...]] |

| | |
|---|---|
| 5 | [...] |
| 6 | |

| | |
|---|---|
| 7 | NNN is a three digit number used to define the |
| 8 | order of execution for the scripts. See below |
| 9 | for more details on the use of this number. |
| 10 | |
| 11 | action is one of: |

| 12 | preview_add_msg | Report a message |
|---|---|---|
| 13 | | indicating what |
| 14 | | preview_add will |
| 15 | | do. |
| 16 | | |
| 17 | preview_add | Execute the |
| 18 | | preview add |
| 19 | | operation. No |
| 20 | | changes are made |
| 21 | | to the software as |
| 22 | | a result of this |
| 23 | | action, according |
| 24 | | to one embodiment. |
| 25 | | For example, the |
| 26 | | intent is to give |
| 27 | | the user an idea |
| 28 | | of whether the |
| 29 | | resource(s) can be |
| 30 | | safely added. |
| 31 | | |
| 32 | prep_add_msg | Report a message |
| 33 | | indicating what |
| 34 | | prep_add will do. |
| 35 | | |
| 36 | prep_add | Execute prepare to |
| 37 | | add actions. |
| 38 | | |
| 39 | undo_prep_add_msg | Report a message |
| 40 | | indicating what |
| 41 | | undo_prep_add will |
| 42 | | do. |
| 43 | | |
| 44 | undo_prep_add | Undo the action |
| 45 | | taken on a |
| 46 | | previous prep_add |
| 47 | | operation. |
| 48 | | |
| 49 | post_add_msg | Report a message |
| 50 | | indicating what |
| 51 | | post_add will do. |
| 52 | | |
| 53 | post_add | Execute post add |
| 54 | | actions. |
| 55 | | |
| 56 | preview_delete_msg | Report a message |
| 57 | | indicating what |
| 58 | | preview_delete |
| 59 | | will do. |
| 60 | | |
| 61 | preview_delete | Execute the |
| 62 | | preview delete |
| 63 | | operation. No |
| 64 | | changes are made |
| 65 | | to the software as |
| 66 | | a result of this |
| 67 | | action, according |
| 68 | | to one embodiment. |
| 69 | | For example, the |
| 70 | | intent is to give |
| 71 | | the user an idea |
| 72 | | of whether the |
| 73 | | component can be |
| 74 | | safely deleted. |
| 75 | | |
| 76 | prep_delete_msg | Report a message |
| 77 | | indicating what |
| 78 | | prep_delete will |
| 79 | | do. |
| 80 | | |
| 81 | prep_delete | Execute prepare to |
| 82 | | delete actions. |
| 83 | | |
| 84 | undo_prep_delete_msg | Report a message |
| 85 | | indicating what |
| 86 | | undo_prep_delete |
| 87 | | will do. |
| 88 | | |
| 89 | undo_prep_delete | Undo the action |
| 90 | | taken on a |
| 91 | | previous |
| 92 | | prep_delete |
| 93 | | operation. |
| 94 | | |
| 95 | post_delete_msg | Report a message |
| 96 | | indicating what |
| 97 | | post_delete will |
| 98 | | do. |
| 99 | | |
| 100 | post_delete | Execute post |

delete actions.

The scripts are stored in a script structure (refer to TABLE 1) such as a file system or a directory. For example, line 1 indicates that the scripts are stored in a directory that has a similar structure to an “rc” directory, such as “/usr/sbin/ah.d/.”

All scripts that are associated with all of the pieces of software can be executed, according to one embodiment, when a resource becomes a candidate for being dynamically allocated or de-allocated with respect to a piece of software. Further, the scripts can be executed in a lexicographical order as indicated by NNN on line 1. For example, if there are scripts 1, 2, 3 associated respectively with applications A, B, C, then the scripts can be executed in the order of 1, 2, 3. For example, if script A specifies a lower NNN than script B, script A may be executed before script B. According to one embodiment, NNN is a prefix for requesting rather than demanding the order that scripts are executed in. For example, the rationale for not guaranteeing the requested ordering is that an application A could put a script in place with number 001 expecting to be the first script executed. However, a different application B could be installed with the number 000. As a result, application B's script will run first. The purpose of the numbers is to allow application to deliver two scripts, one numbered 001 and the second number 002. As a result of this numbering, the script number 001 will be guaranteed to execute before 002. The scripts can be used as part of deleting and/or removing resources such as cells, CPUs, memory, etc., as indicated on lines 2 to 4.

Scripts can be executed in phases, according to one embodiment. For example, one phase can be used to generate a message using the “_msg” actions, for example. The next phase can be used to involve a script in determining whether allocating or de-allocating a resource will impact a piece of software using the “_preview” actions for example. Another phase can be used to prepare for the allocation or de-allocation of a resource for example using “prep_” actions. And yet another phase can be used to indicate that the allocation or de-allocation has been performed using “post_” actions for example. Lastly, an undo action is provided to reverse the processing that has been performed before an allocation or de-allocation is actually performed using an “undo_” action, as will become more evident.

Actions can be used to designate what the phase is. An argument that indicates the action can be passed to a script. The synopsis in TABLE 1 depicts several actions that can be performed by scripts such as preview_add_msg (line 12), preview_add (line 17), prep_add_msg (line 32), prep_add (line 36), undo_prep_add_msg (line 39), undo_prep_add (line 44), post_add_msg (line 49), post_add (line 53), preview_delete_msg (line 56), preview_delete (line 61), prep_delete_msg (line 76), prep_delete (line 81), undo_prep_delete_msg (line 84) undo_prep_delete (line 89), post_delete_msg (line 95), and post_delete (line 100).

There are several different types of purposes that the actions can be used to achieve. For example, some of the actions can be used in adding resources (lines 12 to 55) and other actions can be used for deleting resources (lines 56 to 100). In another example, some actions can be used to provide a system administrator with information as to the status for dynamically allocating resources. For example, message actions can be used for providing information for a system administrator, such as preview_add_msg, prep_add_msg, undo_prep_add_msg, post add_msg, etc. which end in “_msg”. More specifically, if a system is preparing to allocate a resource, such as a CPU, for use by an application A, one or more scripts can be executed with a prep_add_msg causing message(s) to be logged, for example, stating that the system is preparing to add the CPU to the application A, for example. In the event of a problem, the message can help the system administrator to determine during what phase of operation the problem occurred. The messages can be used to provide a systems administrator with a consolidated view of what is happening with regards to a system.

In another example, as already described herein, pieces of software are involved in the determination of whether resources are allocated or de-allocated with respect to the piece of software. According to one embodiment, the preview actions, such as preview_add, preview delete, etc. which include a “preview_” in the actions name, can be used to allow pieces of software to be involved in the determination of whether a resource can be allocated or de-allocated. For example, referring to FIG. 3 assume that CPU 322 is going to be de-allocated from partition 310 and allocated to partition 370. Also assume that scripts 270 include a script 1 associated with application 350 and a script 2 associated with application 360. The scripts 1, 2 can be executed with the “preview_delete” action to determine the impact that removing CPU 370 would have on applications 350 and 360.

In yet another example, an action can be used to give pieces of software an opportunity to prepare for an allocation or de-allocation of a resource prior to the allocation or de-allocation being performed. As a result, the actual allocation or de-allocation is performed more quickly than if the software had not prepared for the allocation or de-allocation. In still another example, an action can be used to inform pieces of software that an allocation or de-allocation has already been performed.

In one embodiment, the processing of an allocation or de-allocation of a resource can be undone prior to the allocation or de-allocation actually being performed. For example, assume that the /tmp directory is to be removed. In the prep_phase, the /tmp directory can be moved for example to another directory, such as a /prep/tmp directory. If a determination is made that the /tmp directory should not be removed, an “undo_” action can be performed to move the /prep/tmp directory back to the /tmp directory, thus, applications can be allowed to perform the necessary cleanup tasks. Therefore, by saving enough information during a prepare phase an “undo_” action can be performed. According to one embodiment, the “undo_” action is supported during the “prep_” phase, for example, because once the resource has actually been allocated or de-allocated, as indicated by a “post_” action, it would be too late to perform the “undo_” action.

Scripts can be used for modifying a system to provide dynamic allocation of resources, for example, by adding (extends the system's ability) a script to or removing (reduces the system's ability) a script from a script structure, such as any one of the three script structures depicted in TABLE 1.

Further, scripts can provide an application handshake controller 120 with information that can be used for critical resource analysis (CRA). As a part of critical resource analysis, a script may attempt to obtain information, for example, by querying an application, such as an Oracle™ database, analyzing stored state information for a piece of software, running a ps command, etc..

As a part of critical resource analysis, the script can indicate to the application handshake controller 120 that the resource can be allocated or de-allocated or that the resource should not be allocated or de-allocated. Further, the script can indicate that the operation (e.g., allocation or de-allocation) should be cancelled, for example. More specifically, scripts can return a value to a calling program, such as an application handshake controller 120. Along with the return value, a script can write text to stderr and/or stdout. The return value, text written to stdout, and text written to stderr can be posted in a single event and can be logged, for example, when the script is exited. The event priority can be based on the return value of the script. The following table 3 depicts examples of values that a script can return along with corresponding event priority and the effect that the return value could have in the case of a Cell OL* operation, for example, according to embodiments of the present invention:

TABLE 3
results, return values, Event Priority, etc.

| Result | Return Value | Event Priority | Cell OL* Result |
|---|---|---|---|
| Success | 0 | 200 (Notice) | Continues normally |
| Warning | 1 | 300 (Warning) | Continues normally |
| | | | (administrator monitors |
| | | | operation and may elect |
| | | | to cancel) |
| Error | 2 | 400 (Error) | Operation Aborted. Refer |
| | | | to description of Undo |
| | | | for details. |

Software could use the return values, etc. depicted in TABLE 3 above, for example, as a part of critical resource analysis and cause an operation to be aborted, for example, by returning an error code as described above. An option could be provided to allow the aborting of an operation to be overridden. In a second example, a script can return a warning, which can be used to elevate the corresponding event priority. Under most circumstances this will not alter the behavior of the operation, according to one embodiment. However, a systems administrator monitoring the operation can cancel the operation upon seeing the elevated event priority.

Canceling an operation for example during a “prep_” action could result in an “undo_” action being performed. The operation could be canceled due to encountering an error which prevents an operations completion or receiving an error return code from a script, among other things. The error which prevents the operation could be from an underlying infrastructure, such as the kernel, manageability firmware, system firmware, etc.. In the case of a cancellation request while processing a “prep_” action, the following actions can be taken, according to one embodiment:
1) allow the currently executing script to run to completion.
2) prevent the execution of scripts that have not yet been executed.
3) execute all scripts that have completed execution prior to receiving the cancellation request in reverse order with the “undo_” action.

The same argument list can be provided when the operation is being undone as when it was original executed.

### Operational Examples

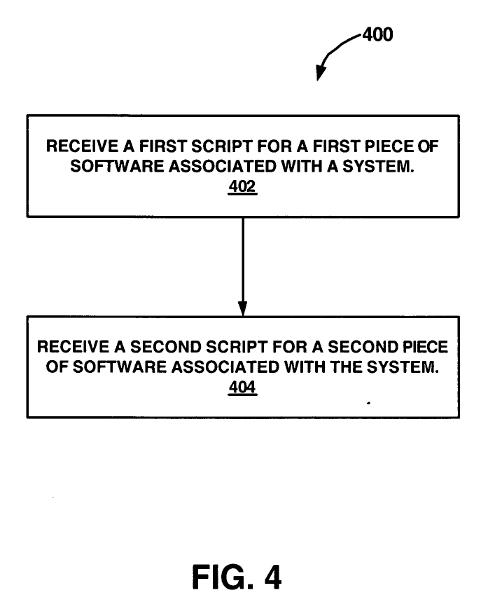

FIG. 4 depicts a flowchart 400 for dynamically allocating resources used by software, according to embodiments of the present invention. Although specific steps are disclosed in flowchart 400, such steps are exemplary. That is, embodiments of the present invention are well suited to performing various other steps or variations of the steps recited in flowchart 400. It is appreciated that the steps in flowchart 400 may be performed in an order different than presented, and that not all of the steps in flowchart 400 may be performed. All of, or a portion of, the embodiments described by flowchart 400 can be implemented using computer-readable and computer-executable instructions which reside, for example, in computer-usable media of a computer system or like device.

As described above, certain processes and steps of the present invention are realized, in one embodiment, as a series of instructions (e.g., software program) that reside within computer readable memory of a computer system (system 200 or computers 210, 240, 300 depicted in either FIGS. 2 or 3) and are executed by the system. When executed, the instructions cause the computer system to implement the functionality of the present invention as described below.

For the purposes of illustration, the discussion of flowchart 400 shall refer to: (1) the structures depicted in FIG. 2, (2) the synopsis of a script depicted in TABLE 2, and (3) the script structures depicted in TABLE 1.

In step 402, a first script for a first piece of software associated with a system is received. For example, a user of computer 240 can use a script interface 110 to associate, for example by installing an application, a script B (line 3 of TABLE 1) with a first piece of software, such as application 260.

In step 404, a second script for a second piece of software associated with the system is received. For example, a second piece of software, such as application 230 which resides on computer 210 may have been migrated to computer 240. As a part of enabling the application handshake controller 120 to allow the application 230 to be involved in determining how resources are allocated and as a part of enabling the application handshake controller 120 to minimize or possibly even eliminate disruptions to application 230 when allocating and/or de-allocating resources to/from application 230, a second script A can be received by the system 200. For example, a user of computer 240 can use the script interface 110 to associate a script A (line 2 of TABLE 1) with the second piece of software (e.g., application 230 that is or will be migrated to computer 240). Thus, by receiving script A, the system 200 can easily be extended to provide dynamic allocation of resources.

Further, the application handshake controller 120 can use script A, as described herein, to involve application 230 in determining whether resources can be allocated to or de-allocated from application 230, thus, minimizing if not eliminating disrupts to application 230. For example, when a resource is going to be de-allocated, the application handshake controller 120 can execute script B with a sequence of actions. The sequence of actions, according to one embodiment, include a prep_delete_msg, a prep_delete, a post delete_msg, and a post_delete. The prep_delete_msg action can cause the script to generate a message indicating that a delete is going to be performed. The message can be logged or recorded so that a systems administrator can see it.

Then the script can be executed with the prep_delete action to inform the script that the delete is going to be performed and allow the script to prepare for the delete for example by saving information in the event of an undo action and/or determine determining whether the delete should be performed. For example, the script can return an indication that the delete will not impact the associated piece of software negatively. Alternatively, the script can return an indication that the delete will impact the performance of the piece of software or violate a service agreement, among other things. If for example the script indicates that the delete will not impact the performance of the software, then the application handshake controller 120 can proceed with the delete operation. After the delete operation has been performed the script can be executed with the post_delete_msg. The script can generate a message indicating a delete has been performed. The message can be logged or recorded so that a systems administrator can see it. Then the script can be executed with a post_delete action indicating that the delete has been performed.

Similarly, the application handshake controller 120 can use script B, as described herein, to involve application 260 in determining whether resources can be allocated to or de-allocated from application 260, among other things.

### Conclusion

According to embodiments of the present invention, applications are involved in the determination of whether an allocation or de-allocation of a resource will impact the applications, thus, enabling applications to “size” themselves (e.g., respond to the potential or actual allocation or de-allocation) appropriately before or after resource changes are dynamically made to a system.

According to embodiments of the present invention, critical software errors can be caught and handled before resources changes are made to a system. These critical software errors in the case of conventional systems would otherwise go uncaught until after the resource change is performed and could seriously compromise the state of an application and/or an operating system.

According to embodiments of the present invention, consistent logging and event reporting is provided, for example using the “_msg” actions and can be sent as events for consumption by management tools.

According to embodiments of the present invention, industry standard designs, such as a directory that has a similar structure to the “rc” directory, etc., are leveraged for simple application integration.

According to embodiments of the present invention, dynamic resource allocation is allowed to occur more quickly because applications can be pro-active about releasing resources, for example during a prep_action, which will be de-allocated.

According to embodiments of the present invention, applications are allowed to perform better as a result of being given the opportunity to “size” themselves when new resources are added or deleted.

Embodiments of the present invention provide independence between applications. For example, each application need not understand or know about other applications in order to use scripts, to communicate with a application handshake controller 120 using scripts, etc.. For example, a script for an application can be added to a script directory and the application handshake controller 120 can automatically begin to use the script for the purpose of dynamic resource allocation, as described herein.

According to embodiments of the present invention, extending a system to provide dynamic resource allocation for a piece of software is easy. For example, by adding a script to a script directory, the system can automatically include applications in the resource allocation process for the purpose of initiating dynamic resource allocation.

What is claimed is:

1. A method of dynamically allocating resources used by software, the method comprising:
receiving a first script for a first piece of software associated with a system, wherein the first script enable the first piece of software to respond to dynamic allocation of the resources; and
receiving a second script for a second piece of software to be associated with the system, wherein the second script enables the second piece of software to respond to dynamic allocation of the resources, wherein the system can be extended to provide dynamic allocation of the resources.

2. The method as recited in claim 1,
wherein the receiving the first script for the first piece of software further comprising receiving the first script for the first piece of software that is selected from a group consisting of an operating system and an application; and
wherein the receiving the second script for the second piece of software further comprising receiving the second script for the second piece of software that is selected from a group consisting of an operating system and an application.

3. The method as recited in claim 1,
wherein the receiving the first script for the first piece of software further comprising receiving the first script for the first piece of software, wherein the first script can be executed with an action that is selected from a group consisting of message, preview, and prepare; and
wherein the receiving the second script for the second piece of software further comprising receiving the second script for the second piece of software, wherein the second script can be executed with an action that is selected from a group consisting of message, preview, and prepare.

4. The method as recited in claim 1, further comprising:
using the first script and the second script to determine how allocating a resource with regards to the first piece of software or the second piece of software will affect the first piece of software or the second piece of software.

5. The method as recited in claim 4, further comprising:
using the information determined by the scripts to adjust the amount of resources to be allocated.

6. The method as recited in claim 1,
wherein the receiving the first script for the first piece of software associated with the system, wherein the first script enables the first piece of software to respond to dynamic allocation of the resources further comprises receiving the first script for the first piece of software associated with the system, wherein the first script enable the first piece of software to respond to dynamic allocation of the resources that are selected from a group consisting of central processing units (CPUs), memory, and input/output (IO) devices; and
wherein the receiving the second script for the second piece of software associated with the system, wherein the second script enables the second piece of software to respond to dynamic allocation of the resources further comprises receiving the second script for the second piece of software associated with the system, wherein the second script enable the second piece of software to respond to dynamic allocation of the resources that are selected from a group consisting of central processing units (CPUs), memory, and input/output (IO) devices.

7. The method as recited in claim 1, further comprising:
storing the first script and the second script in a script directory.

8. The method as recited in claim 7, wherein the storing the first script and the second script in the script directory further comprising:
storing the first script and the second script in directory that has a similar structure to an “rc” directory.

9. An apparatus for dynamically allocating resources used by software, the method comprising:
a script interface for receiving a first script for a first piece of software associated with a system, wherein a application handshake controller enables the first piece of software to respond to dynamic allocation of the resources by using the first script; and
the script interface for receiving a second script for a second piece of software to be associated with the system, wherein the application handshake controller enables the second piece of software to respond to dynamic allocation of the resources by using the second script, wherein the system can be extended to provide dynamic allocation of the resources.

10. The apparatus of claim 9, wherein the first piece of software and the second piece of software are selected from a group consisting of an operating system and an application.

11. The apparatus of claim 9, wherein the first script and the second script can be executed with an action that is selected from a group consisting of message, preview, and prepare.

12. The apparatus of claim 9, wherein the resources are selected from a group consisting of central processing units (CPUs), memory, and input/output (IO) devices.

13. The apparatus of claim 9, wherein the first script and the second script are stored in a script directory.

14. The apparatus of claim 13, wherein the script directory that has a structure similar to an “rc” directory.

15. A computer-usable medium having computer-readable program code embodied therein for causing a computer system to perform a method of dynamically allocating resources used by software, the method comprising:
receiving a first script for a first piece of software associated with a system, wherein the first script enable the first piece of software to respond to dynamic allocation of the resources; and
receiving a second script for a second piece of software to be associated with the system, wherein the second script enables the second piece of software to respond to dynamic allocation of the resources, wherein the system can be extended to provide dynamic allocation of the resources.

16. The computer-usable medium of claim 15, wherein the computer-readable program code embodied therein causes a computer system to perform the method, and:
wherein the receiving the first script for the first piece of software further comprising receiving the first script for the first piece of software that is selected from a group consisting of an operating system and an application; and
wherein the receiving the second script for the second piece of software further comprising receiving the second script for the second piece of software that is selected from a group consisting of an operating system and an application.

17. The computer-usable medium of claim 15, wherein the computer-readable program code embodied therein causes a computer system to perform the method, and:
wherein the receiving the first script for the first piece of software further comprising receiving the first script for the first piece of software, wherein the first script can be executed with an action that is selected from a group consisting of message, preview, and prepare; and
wherein the receiving the second script for the second piece of software further comprising receiving the second script for the second piece of software, wherein the second script can be executed with an action that is selected from a group consisting of message, preview, and prepare.

18. The computer-usable medium of claim 15, wherein the computer-readable program code embodied therein causes a computer system to perform the method, and wherein the method further comprises:
using the first script and the second script to determine how allocating a resource with regards to the first piece of software or the second piece of software will the first piece of software or the second piece of software.

19. The computer-usable medium of claim 15, wherein the computer-readable program code embodied therein causes a computer system to perform the method, and:
wherein the receiving the first script for the first piece of software associated with the system, wherein the first script enable the first piece of software to respond to dynamic allocation of the resources further comprises receiving the first script for the first piece of software associated with the system, wherein the first script enable the first piece of software to respond to dynamic allocation of the resources that are selected from a group consisting of central processing units (CPUs), memory, and input/output (IO) devices; and
wherein the receiving the second script for the second piece of software associated with the system, wherein the second script enable the second piece of software to respond to dynamic allocation of the resources further comprises receiving the second script for the second piece of software associated with the system, wherein the second script enable the second piece of software to respond to dynamic allocation of the resources that are selected from a group consisting of central processing units (CPUs), memory, and input/output (IO) devices.

20. The computer-usable medium of claim 15, wherein the computer-readable program code embodied therein causes a computer system to perform the method, and wherein the method further comprises:
storing the first script and the second script in a script directory.

21. The computer-usable medium of claim 15, wherein the computer-readable program code embodied therein causes a computer system to perform the method, and wherein the method further comprises:
using the first script and the second script to determine how allocating a resource with regards to the first piece of software or the second piece of software will the first piece of software or the second piece of software.
